(19) United States
(12) Patent Application Publication
(10) Pub. No.: US 2022/0163396 A1
(43) Pub. Date: May 26, 2022

(54) OPTICAL ASSEMBLIES

(71) Applicant: Hewlett-Packard Development Company, L.P., Spring, TX (US)

(72) Inventors: Todd Goyen, Vancouver, WA (US); Joshua M. Hunsaker, Vancouver, WA (US); Brian Hupy, Vancouver, WA (US)

(73) Assignee: Hewlett-Packard Development Company, L.P., Spring, TX (US)

(21) Appl. No.: 17/414,984

(22) PCT Filed: Jul. 30, 2019
(86) PCT No.: PCT/US2019/044064

§ 371 Date: Jun. 17, 2021

(51) Int. Cl. G01J 5/08; G01J 5/02; G01J 5/48

(52) U.S. Cl. CPC G01J 5/08; G01J 2005/0077; G01J 5/485; G01J 5/027

(57) ABSTRACT

An optical assembly may include a thermal sensor and a temperature source between the optical assembly and a viewing area of the thermal sensor. The temperature source may provide a first reference temperature and a second reference temperature. A controller may cause the thermal sensor to sense thermal images of the temperature source at a first reference temperature and a second reference temperature and determine a contamination level of the optical assembly or a damage to the optical assembly based on the thermal images.

### BACKGROUND

Optical assemblies may be used as part of the control or quality assurance in automated processes. The optical assembly may capture images of a viewing area and alter processes, such as a temperature used in a three-dimensional (3D) printer.

### BRIEF DESCRIPTION OF THE DRAWINGS

Various examples will be described below referring to the following figures:

FIG. 1 shows an apparatus including an optical assembly and a temperature source in accordance with various examples;

FIG. 2 shows a system with an apparatus and a shutter between the apparatus and a viewing area in accordance with various examples;

FIG. 3 shows a computer-readable medium with instructions to determine a contamination in accordance with various examples; and

FIG. 4 shows a method of determining a contamination level of an optical assembly based on a temperature difference in accordance with various examples.

### DETAILED DESCRIPTION

When optical assemblies are used in an automated environment, the optical assemblies may become contaminated or damaged. Contaminants may collect on a sensor, lens, or a shield of the optical assembly. The assembly may be damaged, such as a scratch on the lens or shield, or an image sensor may be affected. The contaminants or damage may affect the quality of the image obtained. When the optical assembly is used in an automated process, the contamination or damage may cause errors in the process.

An optical assembly may include a thermal sensor. A temperature source may provide a first specified temperature to the optical assembly and then provide a second specified temperature to the optical assembly. The presence of contaminants or damage may affect the temperature seen by the thermal sensor. By comparing a thermal image capture with information captured when the optical assembly is in an initial known state, such as a clean state, contamination or damage to the optical assembly may be detected.

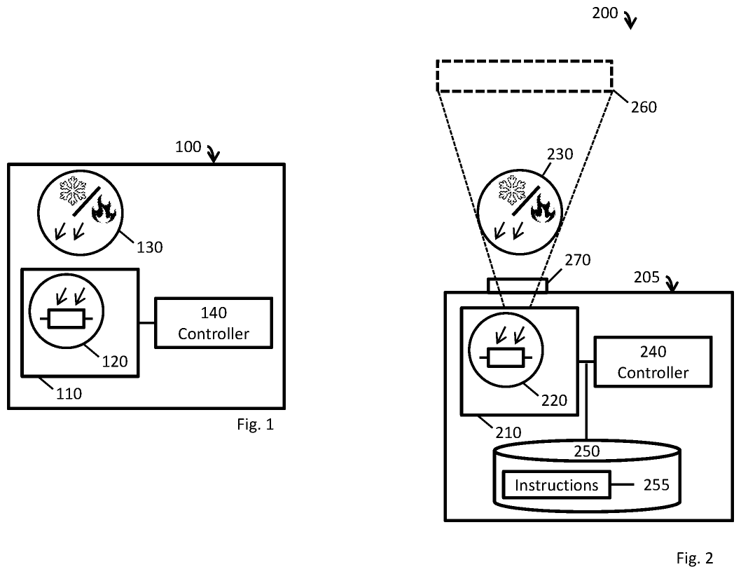

FIG. 1 shows an apparatus 100 including an optical assembly 110 and a temperature source 130 in accordance with various examples. The apparatus 100 includes a controller 140. The controller 140 is coupled to the optical assembly 110 and may be coupled to the temperature source 130, such as via a bus. The optical assembly 110 includes a thermal sensor 120. The optical assembly 110 may include a housing, a lens, and a shield.

The controller 140 may cause the thermal sensor 120 to sense thermal images. The images may comprise a two-dimensional array of pixels. The temperature source 130 may provide a first reference temperature at a first point in time. The temperature source 130 may be positioned to cover the field of view of the thermal sensor 120. The temperature source 130 may include a surface that is heated or cooled to the first reference temperature. There may be some variations in temperature along the surface of the temperature source 130, based on the specifications of the temperature source 130. The controller 140 may cause the thermal sensor 120 to sense a first thermal image of the temperature source 130 at the first point in time. The temperature source 130 may provide a second reference temperature at a second point in time. The second point in time may be a short time after the first point in time, such as less than 30 seconds. The controller 140 may cause the thermal sensor 120 to sense a second thermal image of the temperature source 130 at the second point in time. The first point in time and second point in time may take place at a designated time, such as in a factory when the optical assembly is in a clean state. The controller 140 may store data regarding the first and second thermal images, a comparison of the first and second thermal images, or a statistical analysis of the first and second thermal images as a reference point. The data may be stored in a computer-readable medium.

The temperature source 130 may provide the first reference temperature at a third point in time. The controller 140 may cause the thermal sensor 120 to sense a third thermal image of the temperature source 130 at the third point in time. The temperature source 130 may provide the second reference temperature at a fourth point in time. The fourth point in time may be a short time after the third point in time, such as 30 seconds. The time difference between the first and second points in time and the time difference between the third and fourth points in time may be within a specified time allowance, such as a 15 to 20 second window. The controller 140 may cause the thermal sensor 120 to sense a fourth thermal image of the temperature source 130 at the fourth point in time. The controller 140 may determine a contamination level of the optical assembly or of damage to the optical assembly based on the first, second, third, and fourth thermal images.

In various examples, the controller 140 may control the temperature source 130. The controller 140 may control the temperature to be provided by the temperature source 130. The controller 140 may control an actuator that moves the temperature source 130 to be in front of the thermal sensor 120 or to unblock the view of the thermal sensor 120.

In various examples, the controller 140 may determine a contamination level based on the first, second, third, and fourth thermal images. The first thermal image may include a tare, non-uniformity correction (NUC), flat field calibration (FFC), or other image performed in the factory or during a calibration. The first thermal image may be used to determine a temperature offset for the thermal sensor 120. The second thermal image may be sensed shortly after the first thermal image, such as in the factory or during calibration. The second thermal image may show a variation in the response curve at the second temperature, such as due to non-linear characteristics of the optical assembly 110. The third and fourth thermal images may be sensed in the field after some amount of use of the apparatus 100. Contamination may have built up on the optical assembly 110, such as on a lens, on a shield, or on the thermal sensor 120. The optical assembly 110 may have been damaged, such a scratch on a shield. The third thermal image may include a tare, NUC, FFC, or other image performed in the field to determine a temperature offset for the thermal sensor 120. In providing the first reference temperature, the temperature source 130 may heat up contaminants on or in the optical assembly 110. The contaminants may produce a colder spot in the fourth thermal image, as the contaminants may absorb or blocking the heat from the temperature source 130. If the second reference temperature is colder than the first reference temperature, the contamination may produce a hotter spot in the fourth thermal image due to some retained heat, depending on the temperature difference. The controller 140 may compare the fourth thermal image to the second thermal image to determine a contamination level. The second thermal image may have some temperature variation due to the precision of the optical assembly 110 or the temperature source 130. If the fourth thermal image has more or a different temperature variation, it may indicate the presence of contamination. The controller 140 may compare a difference between the first and second thermal images with a difference between the third and fourth thermal images. For example, a comparison of the first and second thermal images may indicate a temperature increase of 10° C.±0.1° C. A comparison of the third and fourth thermal images may indicate a temperature increase of 9.4° C.±1.3° C. The difference between the comparisons may indicate a contamination level.

In various examples, the controller 140 may perform statistical analysis as part of determining a level of contamination. A statistical analysis of the first and second thermal images may be performed and compared against the third and fourth thermal images or against a statistical analysis of the third and fourth thermal images. Storing the statistical analysis may consume less storage space than storing the thermal images. Comparing the statistical analysis with the third and fourth thermal images or their statistical analysis may use less computational bandwidth.

In various examples, the controller 140 may determine damage to the optical assembly 110 based on the first, second, third, and fourth thermal images. A damaged pixel, or group of pixels, of the thermal sensor 120 may show up as a variation from the expected temperature in the first, second, third, and fourth thermal images and display dissimilar behavior to the surrounding pixels. A scratch or deformation of a shield or lens may cause a concentration or dispersal of heat to show up in the thermal images. Hot or cold spots showing up in both the third and fourth thermal images that were not present in the first or second thermal images may indicate damage to the optical assembly 110 after use. Hot or cold spots showing up in both the first and second thermal images may indicate damage to the optical assembly 110 during manufacture or assembly.

In various examples, the optical assembly 110 may provide feedback for a temperature control. The apparatus 100 may be part of a three-dimensional (3D) printer. In examples, chemical binder systems and metal additive printing and manufacturing techniques and systems are included in the scope of this disclosure. The temperature control may control a heating or cooling element, such as for heating a filament to use for printing, or providing more printing agent that cools the object being printed, as the heat is dissipated across the additional printing agent. The temperature control may be controlling a temperature of the printing process, with the optical assembly 110 measuring the temperature and providing feedback. Based on the temperature measured by the optical assembly 110, the temperature control may increase or decrease the temperature being used during the printing process.

FIG. 2 shows a system 200 with an apparatus 205 and a shutter 230 between the apparatus 205 and a viewing area 260 in accordance with various examples. The apparatus 205 includes an optical assembly 210, a controller 240, and storage 250. The storage 250 may include a computer-readable medium and store machine-readable instructions 255. The storage 250 may include a hard drive, solid state drive (SSD), flash memory, or random access memory (RAM). The machine-readable instructions 255 may be for execution by the controller 240. The controller 240 may be coupled to the storage 250 and the optical assembly 210, such as via a bus. The controller 240 may comprise a microprocessor, a microcomputer, a microcontroller, a field programmable gate array (FPGA), or discrete logic. The controller 240 may execute machine-readable instructions 255 that implement the methods described herein.

The optical assembly 210 includes a temperature sensor 220. The optical assembly 210 may include lenses or a housing. The optical assembly 210 has a viewing area 260, which may be external to the apparatus 205. The viewing area 260 may be internal or external to the system 200 that includes the apparatus 205.

The shutter 230 includes a temperature source to provide reference temperatures for imaging. The shutter 230 may include an actuator to position the shutter. When the shutter 230 is to provide a reference temperature, the actuator may position the shutter 230 between the optical assembly 210 and the viewing area 260 of the optical assembly 210. When the shutter 230 is positioned before the viewing area 260, the optical assembly 210 may adjust its focus to the shutter 230, such as by adjusting the focal length provided by any lenses of the optical assembly 210. At other times, the actuator may position the shutter 230 away from blocking the optical assembly's 210 view of the viewing area 260. The controller 240 may be coupled to control the shutter 230 and any actuator.

In various examples, the shutter 230 may include a heating element and a surface to be heated. The heating element may be a resistive heating source or other source to provide heat. The heating element may heat up a surface, such as an aluminum emitter. An aluminum emitter may be thermally flat and have a relatively stable thermal profile over time to reduce special heating discrepancies and aging effects. The shutter 230 may include a temperature sensor 220, such as a thermistor to provide feedback to the heating source to control the temperature to a reference temperature. The specification of the shutter 230 may be to provide a reference temperature across the heated surface within a certain tolerance range, such as 110° C.±0.25° C.

The system 200 includes a shield 270. The shield 270 may be part of the optical assembly 210 or a separate component. The shield 270 may protect other portions of the apparatus 205 or the optical assembly 210 from contamination. The shield 270 may be a surface, such as a glass or plastic sheet with a surface to block contaminants from reaching other components. For example, a process performed in the viewing area or nearby the apparatus 205 may cause a splatter of contaminants. A 3D printing process may be performed, where some of the printing substrate splatters in the surrounding area. Contaminants may also collect on the shield 270. The shield 270 may protect other equipment and be easier to clean from the contaminants. In various examples, contaminants may include dust, 3D printing material (e.g., build material, printing fluid, and/or a combination thereof), aerosol, fingerprints, moisture, or other substances that obscure the view of the optical assembly.

In various examples, the determination of contamination or damage may be performed on a pixel-by-pixel basis or as zones of the image or viewing area. Determination of damage or contamination may allow for correction of the image, such as by application of a scaling factor, offset, or polynomial correction. When a predetermined level of contamination is reached for a zone, the information for that zone may be discarded or considered suspect. Information from that zone may be given reduced weight in conclusions drawn from the image data.

In various examples, the viewing area 260 may have multiple zones. The zones may represent manufacturing areas, such as multiple lines on a manufacturing floor or multiple construction areas of a 3D printer. The zones of the viewing area 260 may operate independently. Contamination may reach a high level for one of the zones, but be lower for other zones. The controller 240 may indicate which zones have acceptable levels of contamination. If manufacturing is being run at less than full capacity, manufacturing may be directed to use the zones with lower levels of contamination, so that operations may continue, generally unaffected by the high contamination level of other zones.

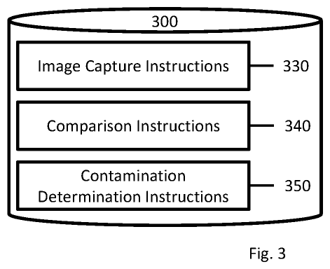

FIG. 3 shows a computer-readable medium 300 with instructions 330, 340, 350 to determine a contamination in accordance with various examples. The computer-readable medium 300 includes image capture instructions 330, comparison instructions 340, and contamination determination instructions 350. The instructions 330, 340, 350 may be machine-readable instructions for execution by a controller.

The image capture instructions 330 may control a thermal sensor to capture images. The images may be captured at different points in time when different reference temperatures are being provided. The capture of the images may be timed to coordinate with the providing of the reference temperatures. In various examples, four reference images may be captured, one at a first reference temperature in the factory, one at a second reference temperature in the factory, one at the first reference temperature in the field, and one at the second temperature in the field. The reference temperatures may be provided by different temperature sources. For example, one temperature source may be used in the factory setting and another temperature source may be used in the field. The first and second reference temperatures may be provided by different temperature sources. Use of multiple temperature sources may be useful to allow for a more accurate temperature source and to present the reference temperatures to the thermal sensor in rapid succession. As the presence of contamination may be more readily determined using images where the reference temperature changes quickly, multiple temperature sources may be used to decrease the delay between imaging the temperature references.

The comparison instructions 340 perform a comparison between the image captures of the reference temperatures. The comparison may be comparing the images themselves, or performing calculations based on the images and comparing the calculations. For example, the comparison instructions 340 may determine an average temperature and the highest deviation from the average temperature for the image of the second temperature in the factory. The comparison instructions 340 may determine an average temperature and the highest deviation from the average temperature for the image of the second temperature in the field. The comparison instructions may compare those averages and the highest deviations to obtain a temperature delta and a deviation delta. Other statistical calculations may be made, such as determining a maximum, minimum, or standard deviation. The calculations may be performed across the image as a whole, or statistics may be calculated for zones of the image.

The contamination determination instructions 350 may take the results of the comparison instructions 340 and determine a level of contamination. The contamination level may use any appropriate system, such as a Boolean value indicating it is contaminated or not, specifying a high, medium, or low level of contamination, or ranges of numeric values, such as a percent may be used. The determined contamination level may indicate whether the optical assembly should be cleaned.

In various examples, the instructions may compare the contamination level against a predetermined threshold. If the threshold is exceeded, a warning or error prompt may be provided to a user or recorded in a log file. A user may make the determination, based on the contamination level, whether the optical assembly is to be cleaned. Such a determination may be performed by the instructions stored in the computer-readable medium 300, when the instructions are executed by a controller.

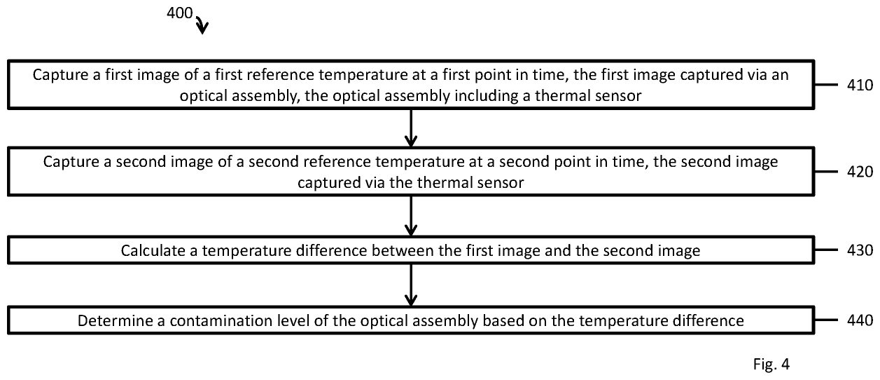

FIG. 4 shows a method 400 of determining a contamination level of an optical assembly based on a temperature difference in accordance with various examples. The method 400 includes capturing a first image of a first reference temperature at a first point in time, the first image captured via an optical assembly, the optical assembly including a thermal sensor (block 410). The method 400 includes capturing a second image of a second reference temperature at a second point in time, the second image captured via the thermal sensor (block 420). The method 400 includes calculating a temperature difference between the first image and the second image (block 430). The method includes determining a contamination level of the optical assembly based on the temperature difference (block 440).

In various examples, the method 400 may include heating a surface to the first or second reference temperature. The heated surface may be placed in front of the optical assembly.

In various examples, the method 400 may include cleaning the optical assembly if the determined contamination level is greater than or equal to a predetermined contamination level.

Although various examples are described herein in the context of thermal printheads, such descriptions also may be extended to piezo printheads. Thus, the features and concepts described above relating to thermal printheads may be modified as needed for use in or with piezo printheads.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An apparatus comprising:
an optical assembly including a thermal sensor;
a temperature source located between the optical assembly and a viewing area of the thermal sensor, the temperature source to provide a first reference temperature and a second reference temperature; and
a controller coupled to the optical assembly, the controller to:
cause the thermal sensor to sense a first thermal image of the temperature source at the first reference temperature at a first point in time;
cause the thermal sensor to sense a second thermal image of the temperature source at the second reference temperature at a second point in time;
cause the thermal sensor to sense a third thermal image of the temperature source at the first reference temperature at a third point in time;
cause the thermal sensor to sense a fourth thermal image of the temperature source at the second reference temperature at a fourth point in time; and
determine a contamination level of the optical assembly or a damage to the optical assembly based on the first, second, third, and fourth thermal images.

2. The apparatus of claim 1 comprising a shutter including the temperature source, wherein the controller causes the shutter to be positioned between the optical assembly and the viewing area when sensing the first, second, third, and fourth thermal images.

3. The apparatus of claim 1, wherein the determination includes:
to calculate a first temperature difference between the first and second thermal images;
to calculate a second temperature difference between the third and fourth thermal images; and
to compare the first temperature difference with the second temperature difference.

4. The apparatus of claim 3, wherein the thermal sensor is to provide feedback to a temperature control corresponding to the viewing area.

5. The apparatus of claim 1, wherein the first thermal image comprises a first zone and a second zone, and the contamination level includes a first contamination value corresponding to the first zone and a second contamination value corresponding to the second zone.

6. A non-transitory computer-readable medium to store machine-readable instructions that, when executed by a processor, cause the processor to:
capture a first image of a first reference temperature via a thermal sensor, a surface being between the first reference temperature and the thermal sensor;
capture a second image of a second reference temperature via the thermal sensor, the surface being between the second reference temperature and the thermal sensor;
compare the first image with the second image; and
determine a contamination level of the surface based on the comparison.

7. The computer-readable medium of claim 6, wherein execution of the instructions by the processor causes the processor to:
capture a feedback image via the thermal sensor; and
control a heating element based on the feedback image and the contamination level.

8. The computer-readable medium of claim 6, wherein execution of the instructions by the processor causes the processor to indicate the contamination level exceeds a predetermined contamination level.

9. The computer-readable medium of claim 6, wherein execution of the instructions by the processor causes the processor to position a shutter before the image sensor, the shutter providing the first reference temperature and the second reference temperature.

10. The computer-readable medium of claim 6, wherein the determination of the contamination level includes a statistical analysis of differences between the first image and the second image.

11. A method comprising:
capturing a first image of a first reference temperature at a first point in time, the first image captured via an optical assembly, the optical assembly including a thermal sensor;
capturing a second image of a second reference temperature at a second point in time, the second image captured via the thermal sensor;
calculating a temperature difference between the first image and the second image; and
determining a contamination level of the optical assembly based on the temperature difference.

12. The method of claim 11 comprising:
placing a shutter before the thermal sensor before the first point in time, the shutter to provide the first reference temperature and the second reference temperature; and
removing the shutter from thermal the image sensor after the second point in time.

13. The method of claim 11 comprising heating a surface to the first reference temperature, wherein capturing the first image includes capturing an image of the surface.

14. The method of claim 11 comprising determining a damage to the optical assembly based on the temperature difference.

15. The method of claim 11 comprising cleaning the optical assembly based on the contamination level, wherein the contamination level is greater than or equal to a predetermined contamination level.
